(19) United States
(12) Patent Application Publication
(10) Pub. No.: US 2006/0144611 A1
(43) Pub. Date: Jul. 6, 2006

(54) Retaining joint of a cable

(76) Inventor: Teh-Tsung Chiu, Taipei Hsien (TW)

Correspondence Address: Teh-Tsung Chiu, 235 Chung - Ho, Box 8-24, Taipei, TW

(21) Appl. No.: 11/029,125

(22) Filed: Jan. 5, 2005

(51) Int. Cl. H01R 9/05

(52) U.S. Cl. 174/74 R

(57) ABSTRACT

A retaining joint of a cable comprises a joint having a hollow body; the body having a resisting portion at a middle portion thereof and two outer threaded portions at two ends of the body; a tightening unit assembled to the joint; the tightening unit being a hollow body; an interior of the tightening unit having an inner threaded portion; one end of the tightening unit being formed as a reduced inner wall; a clamping unit installed between the joint and the tightening unit; the clamping unit having a plurality of elastic clamping sheets; each clamp sheet having a press; and a liner arranged in the clamping unit and being a hollow body; the clamping unit being assembled into the tightening unit and compressed by the reduced inner wall of the tightening unit.

### FIELD OF THE INVENTION

The present invention relates to cable joints, and in particular to a retaining joint of a cable, wherein the joint is not only waterproof, but also a cable wire can be fixed without damage due to pulling or bending. Thereby the present invention is tolerant to movement so as to suffer from the damages of climate, wind, transferring, etc.

### BACKGROUND OF THE INVENTION

With reference to FIG. 1, the retaining joint of a cable includes a joint 1a, a tightening unit 2a assembled to the joint 1, a clamping unit 3a installed between the joint 1a and the tightening unit 2a, and a liner 4a arranged within the clamping unit 3a.

In application, the liner 4a is arranged within the clamping unit 3a. Then the cable wire 5a passes through the tightening unit 2a, the liner 4a and the joint 1a. When an engaging portion 21a in the tightening unit 2a is locked to the combining portion 14a of the body 11a, a reduced inner wall 22a at one end of the tightening unit 2a will clamp the clamping sheets 31a of the clamping unit 3a so that presses 32a of the clamping sheets 31a press an enclosing portion 42a to firmly clamp the cable wire 5a. Since the enclosing portion 42a of the liner 4a does not extend out of the tightening unit 2a. It is not endurable as the cable wire moves rapidly. Thereby the connection is not water-proof. It is not suitable for cable wires of specific sizes. Cable wires of different sizes cannot be used to the joint.

Moreover referring to FIG. 2, another prior art is illustrated. The difference of this one to the former one is that a helical enclosing portion 20a for enclosing the cable wire 5a is extended from a distal end of the tightening unit 2a. Although the enclosing portion 20a serves to enclose and protect the cable wire 5a, the enclosing portion 20a is hollowed, and is not water-proof. When an external force is applied thereon, the helical structure will resist against the movement so that it can not endure the twisting force. Thus, it can not suffer from strong wind or rapid movement.

### SUMMARY OF THE INVENTION

Accordingly, the primary object of the present invention provides a retaining joint of a cable, wherein the joint is not only water proof, but also the cable wire 5 can be fixed without damage by any pulling force or by bending of the joint. Thereby the present invention is endurable to movement so as to suffer from the damage of climate, wind, transferring, etc.

To achieve above object, the present invention provides a retaining joint of a cable. The joint comprises a joint having a hollow body; the body having a resisting portion at a middle portion thereof and two outer threaded portions at two ends of the body; a tightening unit assembled to the joint; the tightening unit being a hollow body; an interior of the tightening unit having an inner threaded portion; one end of the tightening unit being formed as a reduced inner wall; a clamping unit installed between the joint and the tightening unit; the clamping unit having a plurality of elastic clamping sheets; each clamp sheet having a press; and a liner arranged in the clamping unit and being a hollow body; the clamping unit being assembled into the tightening unit and compressed by the reduced inner wall of the tightening unit.

The various objects and advantages of the present invention will be more readily understood from the following detailed description when read in conjunction with the appended drawing.

### BRIEF DESCRIPTION OF THE DRAWINGS

FIG. 1 is an exploded schematic view of the conventional fixing structure of a cable wire.

FIG. 2 is an exploded schematic view of another conventional fixing structure of a cable wire.

FIG. 3A is an exploded schematic view of the retaining joint of a cable of the present invention.

FIG. 3B is another exploded schematic view of the retaining joint of a cable of the present invention.

FIG. 3C is a further exploded schematic view of the retaining joint of a cable of the present invention.

FIG. 4 is an assembly view of FIG. 3.

FIGS. 5 to 7 are schematic cross sectional views of FIG. 4.

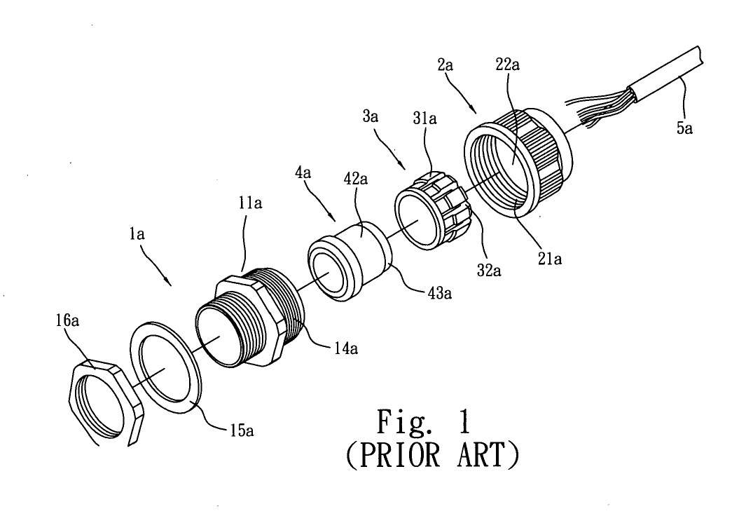

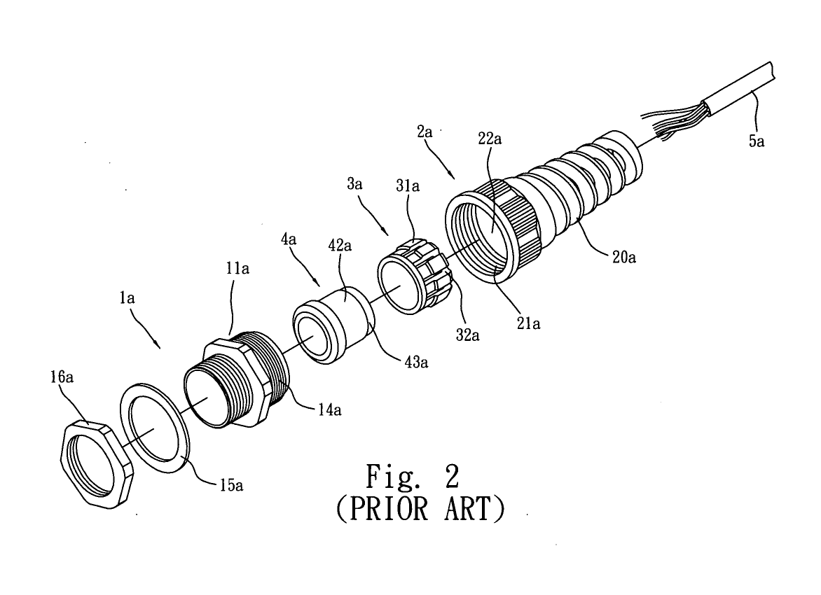

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

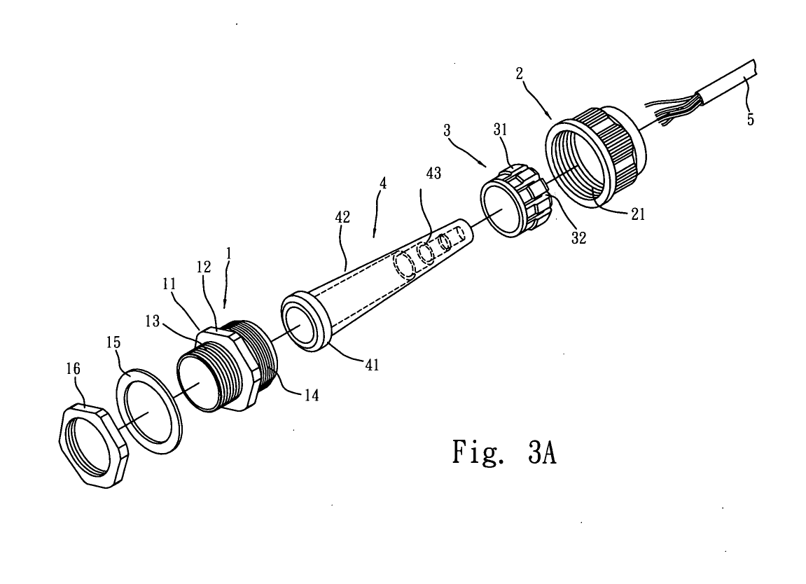

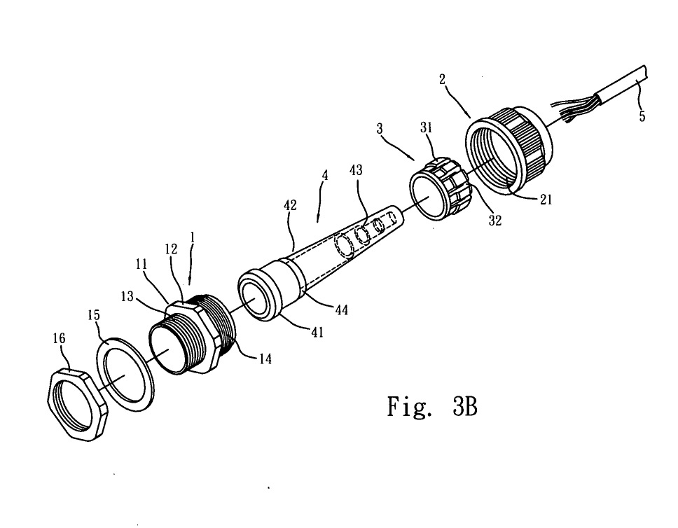

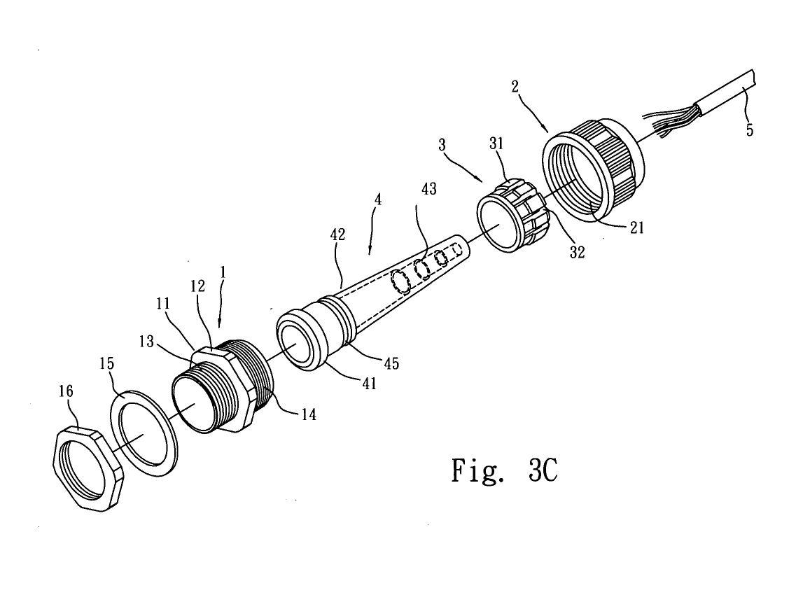

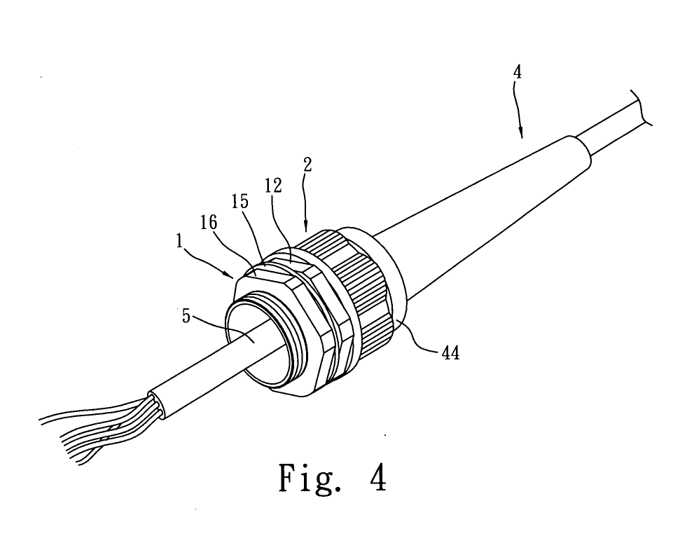

Referring to FIGS. 3A, 3B, 3C and 4, the retaining joint of a cable of the present invention has the following elements. The present invention is water-proof and capable of protecting a cable 5.

A joint 1 has a hollow body 11. The body 11 has a resisting portion 12 at a middle portion thereof and two outer threaded portions 13, 14 at two ends of the body 11. A washer 15 and a male screw 16 are enclosed around the outer threaded portion 13. Thereby the body 11 can be assembled to a spanner or a wall, etc. for being fixed thereon.

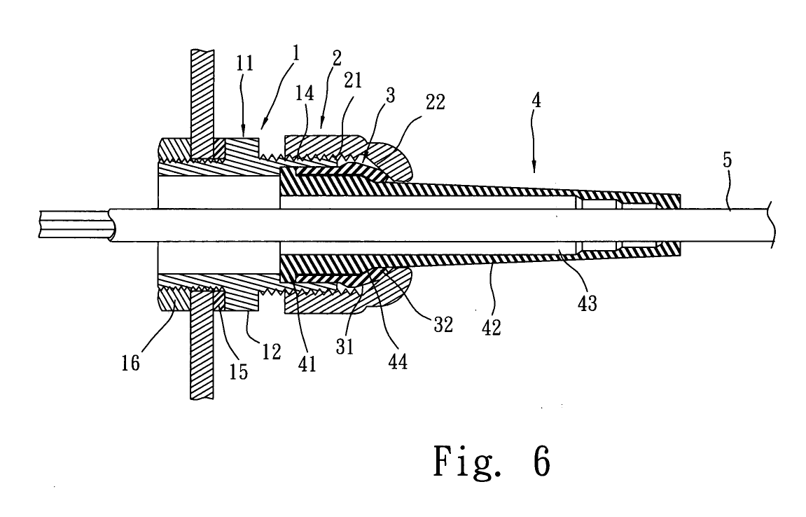

A tightening unit 2 is assembled to the joint 1. The tightening unit 2 is a hollow body. An interior of the tightening unit 2 has an inner threaded portion 21 for combing the thread portions 14. One end of the tightening unit 2 is formed as a reduced inner wall 22 (referring to FIG. 6).

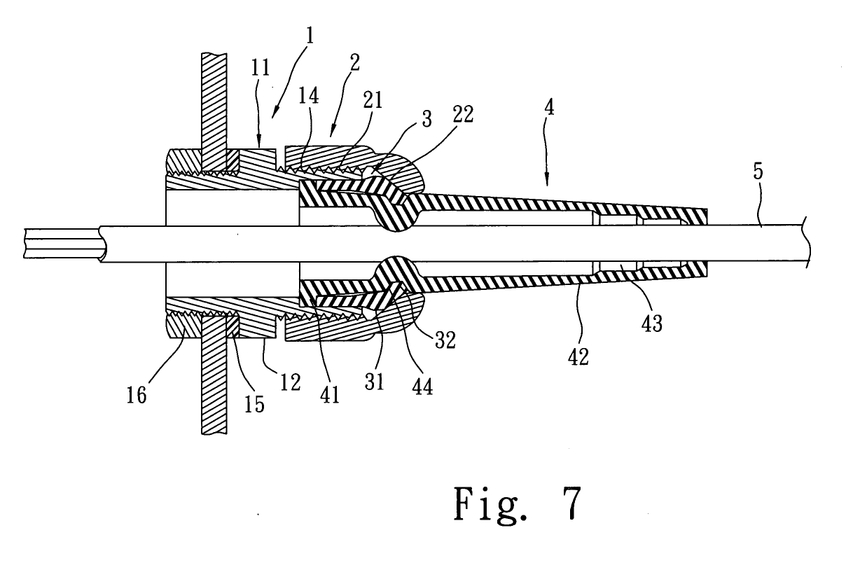

A clamping unit 3 is installed between the joint 1 and the tightening unit 2. The clamping unit 3 has a plurality of elastic clamping sheets 31. Each clamp sheet 31 has a press 32 (referring to FIG. 7).

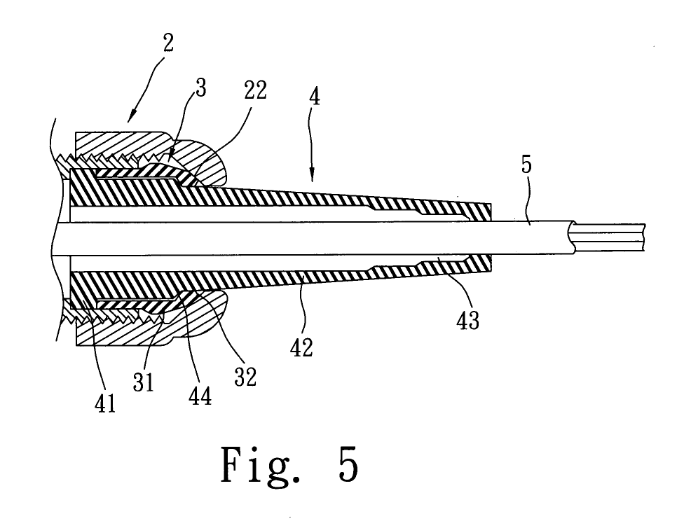

A liner 4 is arranged in the clamping unit 3 and is a hollow body. The clamping unit 3 is assembled into the tightening unit 2 and is compressed by the reduced inner wall 22 of the tightening unit 2 so that the presses 32 of the clamping sheets 31 are pressed. It is preferable, that the liner 4 is made of rubber. A front end thereof has a stopper 41 resisting against an opening of the clamping unit 3. An enclosed portion 42 extends from the stopper 41. In assembly, the enclosed portion 42 is connected to the tightening unit 2. An inner wall of the enclosed portion 42 has a stepped or reduced structure 43 (referring to FIG. 5) so as to match a cable wire 5. The structure 43 is cutable for matching the size of the cable wire 5.

The liner 4 has a recess 44 or a reduce portion 45 (referring to FIG. 3B or 3C) between the enclosing portion 42 and the stopper 41 for clamping the tightening unit 2 further.

With reference to FIGS. 5 to 7, the cross sectional view of the present invention is illustrated. As shown in drawing, in use, the liner 4 is firstly placed in the clamping unit 3. Then the enclosing portion 42 of the liner 4 extends to the external of the clamping unit 3. Then a cable wire 5 passes through the tightening unit 2, the liner 4 and the joint 1. Then inner threaded portion 21 of the tightening unit 2 is engaged to the outer threaded portions 14 of the body 11 of the joint 1. The reduced inner wall 22 at the end of the tightening unit 2 will compress the clamping sheets 31 of the clamping unit 3 so that the presses 32 of the clamping sheet 32 are pressed within the enclosing portion 42 of the liner 4 or the presses 32 press the recess 44 or the stepped portion 45. Thereby the cable wire 5 is clamped.

After assembly, the enclosing portion 42 of the liner 4 extends out of the tightening unit 2. Other than the function of water proof, the cable wire 5 can be fixed without damage due to pulling or bending. Thereby the present invention is tolerated to movement to suffer from the damage of climate, wind, transferring, etc.

Further, the recess 43 of the enclosing portion 42 is designed based on the size of cable wire 5 so as to achieve the object of multi-stage waterproof.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A retaining joint of a cable comprising:
a joint having a hollow body; the body having a resisting portion at a middle portion thereof and two outer threaded portions at two ends of the body;
a tightening unit assembled to the joint; the tightening unit being a hollow body; an interior of the tightening unit having an inner threaded portion; one end of the tightening unit being formed as a reduced inner wall;
a clamping unit installed between the joint and the tightening unit; the clamping unit having a plurality of elastic clamping sheets; each clamp sheet having a press; and
a liner arranged in the clamping unit and being a hollow body; the clamping unit being assembled into the tightening unit and being compressed by the reduced inner wall of the tightening unit so that when the presses of the clamping sheets are pressed; a front end thereof having a stopper will resist against an opening of the clamping unit; an enclosed portion extending from the stopper; in assembly, the enclosed portion is connected to the tightening unit.

2. The retaining joint of a cable as claimed in claim 1, wherein the liner is made of rubber.

3. The retaining joint of a cable as claimed in claim 1, wherein an inner wall of the enclosed portion has a section for matching a cable wire.

4. The retaining joint of a cable as claimed in claim 3, wherein the section is a stepped structure for matching a cable wire.

5. The retaining joint of a cable as claimed in claim 3, wherein the section is a reduced structure for matching a cable wire.

6. The retaining joint of a cable as claimed in claim 3, wherein the section is cutable for matching a size of a cable wire.

7. The retaining joint of a cable as claimed in claim 1, wherein the liner has a recess or a reduce portion between the enclosing portion and the stopper for clamping the tightening unit.
